(19) United States
(12) Patent Application Publication
(10) Pub. No.: US 2002/0075684 A1
(43) Pub. Date: Jun. 20, 2002

(54) Projecting light device of bar code scanner

(76) Inventor: Yu-Chun Chang, Taipei (TW)

Correspondence Address: BACON & THOMAS, 625 Slaters Lane - 4th Floor, Alexandria, VA, 22314, US

(21) Appl. No.: 09/736,218

(22) Filed: Dec. 15, 2000

(51) Int. Cl. F21V 13/02

(52) U.S. Cl. 362/268

(57) ABSTRACT

A projecting light device of a bar code scanner comprises a laser diode, a focusing lens in front of the laser diode, a light shield in front of the focusing lens, and a flat bottom convex lens in front of the light shield. A round hole is formed on the light shield. This round hole serves to confine the size of the light point by focusing the elliptical parallel light beam through the focusing lens so as to output a small round light point. A flat bottom convex lens is positioned in front of light shield for shaping the round small light point from the light shield to be formed as a long light point for being outputted. This long light point does not deform with a distance as a light passes through a slit.

### BACKGROUND OF THE INVENTION

The present invention relates to a projecting light device of a bar code scanner, and especially to a projecting light source generating a long projecting light for being formed with an idea projecting light as scanning bar codes.

The good projecting light produces a good scanning result. In general, the light point has a round shape or an elliptical shape, while the bar codes are long strip shape. Therefore, the idea light point must has a rectangular shape, or an oblong shape, or otherwise an elliptical shape for generating a well reflecting light. The round or near round light point projects to the bar codes will be reflected with a light beam as a sinusoidal wave. This is not like a digital signal. As the bar code is adjudged by the ratio of width to thickness, this reflecting light is not a well object. A rectangular shape or an oblong shape light point projecting to the bar codes will be reflected with a light beam as a rectangular wave which is like a digital signal and thus is beneficial for being adjudged.

To read bar code at a predetermined range, it is beneficial that the projecting light are parallel light beams. Moreover, the size of the light point is suitable for reading the bar codes. Therefore, the current scanning reading device uses a laser light source, moreover, the size of the product is compact and laser diodes are used in most products. In the following, the structure of the laser diode is described.

The laser diode 1 is a projecting light source with a projecting angle of 30 degrees from X axis and a 10 degrees from Y axis so as to project with an elliptical light point. According to aforesaid description, to achieve a larger reading range, a focusing lens 2 is necessary to adjust the light into parallel light beams. It has described that elliptical light is a secondary idea light source, while the laser diode 1 projects with an elliptical light. It is hard to design a non-spherical lens according to the elliptical light of the laser diode 1 and needs a very high cost. Furthermore, at this condition, the size of the light is too large to be used to read a bar code.

A round shape passes through the focusing lens 2 will present as parallel light beams. Since the size is too large, a light shield 6 is necessary to be added to thin the light passed therethrough. Therefore, the light point 7 projecting on the object (bar code) will become a desired small light point. However, the current light shield 6 has a rectangular or an oblong shape which have two defects. The light passing through a slit will generate a grid effect and deforms with the distance. These can be demonstrated by experiment.

### SUMMARY OF THE INVENTION

Accordingly, the primary object of the present invention is to provide a projecting light device of a bar code scanner, wherein an idea long projecting light source is generated, which does not deform with the traveling distance.

Another object of the present invention is to provide a projecting light device of a bar code scanner, wherein a radius of a flat bottom convex lens is deigned according to the range for reading a bar code.

To achieve the aforesaid objects, the present invention provides a projecting light device of a bar code scanner. A round hole is formed on the light shield. This round hole serves to confine the size of the light point. A flat bottom convex lens is positioned in front of light shield for shaping the round small light point from the light shield 3 to be formed as a long light point for being outputted. This long light point does not deform with a distance as a light passes through a slit.

The various objects and advantages of the present invention will be more readily understood from the following detailed description when read in conjunction with the appended drawing.

### BRIEF DESCRIPTION OF THE DRAWINGS

FIG. 1 is a schematic view of a prior art projecting light device of a conventional bar code scanner.

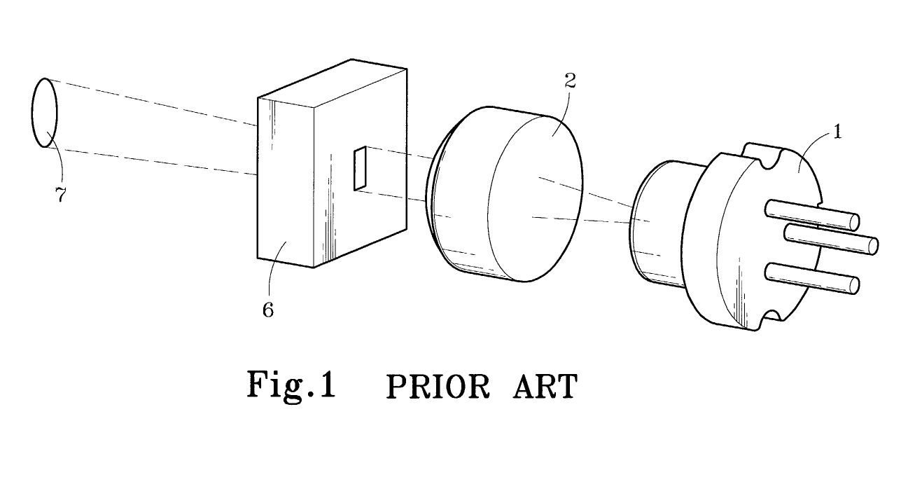

FIG. 2 is a schematic view of the projecting light device of a bar code scanner of the present invention.

FIG. 3 is a schematic view of a projecting light device of the present invention.

FIG. 4 is upper schematic view of FIG. 3.

### DETAILED DESCRIPTION OF THE PREFERRED EMBODIMENTS

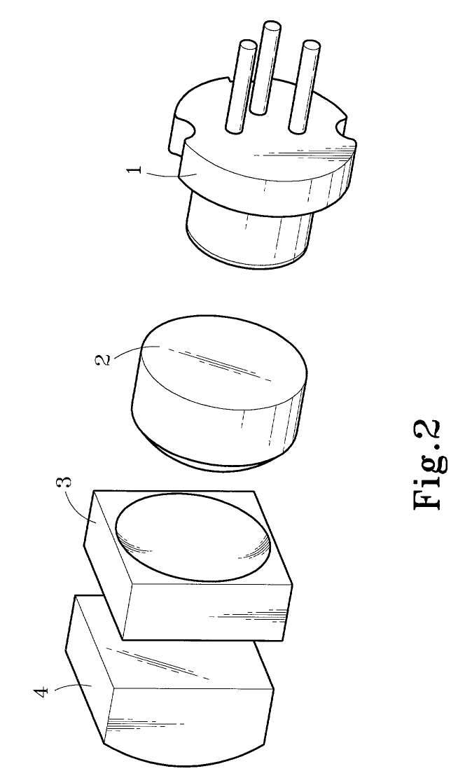

Referring to FIG. 2, a schematic view about the projecting light device of a bar code scanner according to the present invention is illustrated. The projecting light device includes a laser diode 1, a focusing lens 2 in front of the laser diode 1, a light shield 3 in front of the focusing lens 2, and a flat bottom convex lens 4 in front of the light shield 3. Therefore, the light point 5 projecting to the projected object (bar code) does not deform as a light passes through a slit (a dispersion at the periphery of a light point).

The laser diode 1 is a projecting light source with a projecting angle of 30 degrees from X axis and a 10 degrees from Y axis so as to project with an elliptical light point as a light source of the bar code scanner (not shown) for scanning bar codes.

The focusing lens 2 is positioned in front of the laser diode 1 for focusing the elliptical light point from the laser diode 1 to become an elliptical parallel light beams.

The light shield 3 is positioned or adhered to a front side of the focusing lens 2. A round hole 31 is formed on the light shield 3. This round hole 31 serves to confine the size of the light point by focusing the elliptical shape parallel light beam through the focusing lens 2 so as to output a small round light point.

The flat bottom convex lens 4 is positioned in front of light shield 3 for shaping the round small light point from the light shield 3 to be formed as a long light point 5 for being outputted. Therefore, a novel projecting light device is formed.

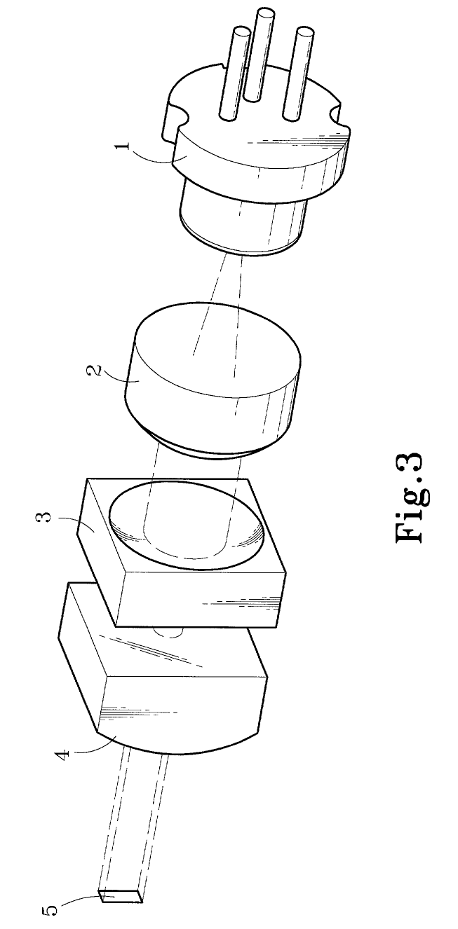

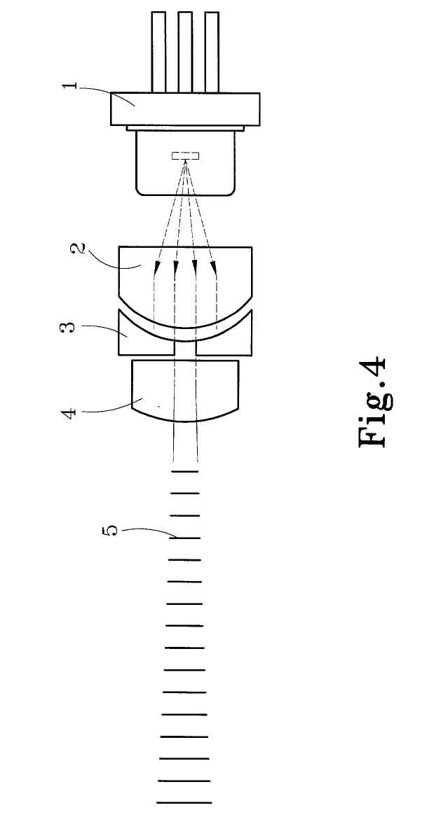

Referring to FIGS. 3 and 4, an upper schematic view of the projecting light device of a bar code scanner according to the present invention is illustrated. As shown in the figure, as a bar code scanner scan an object, the elliptical shape light point from the laser diode 1 passes through the focusing lens 2 to be formed as a parallel light beam. Then, the light point further passes through the round hole 31 of the light shield 3 to be projected out as a round small light point. This round small light point will be formed as a long light point 5 after passing through the flat bottom convex lens 4. It does not deform with a traveling length as a light passes through a slit (as dispersion at the periphery of light). The size of the flat bottom convex lens 4 is deigned according to the range for reading a bar code.

Further the thinner the better for the width of the light shield 3 so that the projecting light projected from the flat bottom convex lens 4 has a preferred effect for reading bar codes.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A projecting light device of a bar code scanner, comprising a laser diode, a focusing lens in front of the laser diode, a light shield in front of the focusing lens, and a flat bottom convex lens in front of the light shield; from aforesaid component, a projecting light projecting to an object (a bar code) for scanning the object; wherein a round hole is formed on the light shield; said round hole serves to confine the size of the light point by focusing the elliptical parallel light beam through the focusing lens so as to output a small round light point; a flat bottom convex lens is positioned in front of light shield for shaping the round small light point from the light shield to be formed as a long light point for being outputted; this long light point does not deform with a distance as a light passes through a slit.

2. The projecting light device of a bar code scanner as claimed in claim 1, wherein the light shield is positioned or adhered to the focusing lens.

3. The projecting light device of a bar code scanner as claimed in claim 1, wherein the width of the light shield is narrow.

4. The projecting light device of a bar code scanner as claimed in claim 1, wherein a radius of the flat bottom convex lens is deigned according to the range for reading a bar code.
